(19) United States
(12) Patent Application Publication
(10) Pub. No.: US 2013/0088084 A1
(43) Pub. Date: Apr. 11, 2013

(54) Networklized DC Power System

(71) Applicant: Hsing-Chung SZU, Taipei City (TW)

(72) Inventor: Hsing-Chung SZU, Taipei City (TW)

(73) Assignee: GCCA INC., Tortola (BV)

(21) Appl. No.: 13/472,746

(22) Filed: May 16, 2012

(30) Foreign Application Priority Data
Oct. 6, 2011 (TW) 100136340

(51) Int. Cl. H02J 9/00

(52) U.S. Cl. 307/66

(57) ABSTRACT

A networklized DC power system includes: a micro DC grid, and a plurality of energy routers connected to the micro DC grid. Each of energy routers includes a controlling module for controlling the energy router. A DC receiving port is coupled for receiving DC power from at least one DC power generating system. An AC receiving port is provided for receiving AC power from an AC power supplying system. A battery charging/discharging port is connected to a battery system for charging or discharging the battery system. A DC outputting port is provided for applying DC voltage to a load. A network interface port is coupled to the micro DC grid, and for receiving the power from the micro DC grid or for transferring power to the other energy routers of the micro DC grid.

### BACKGROUND

1. Field of Invention

The present invention relates to a DC power system. More particularly, the present invention relates to a DC grid system with network configuration for distributing and managing supplying power in the DC grid system.

2. Description of Related Art

In recent, several electronic devices are used in general operation for households with DC voltage. However, the electricity power company always powers 110 volt, 60 HZ AC voltage to the general households. Thus, in practice, a supplying power used in the normal households should include means for transferring the AC voltage to a DC voltage, but the performance of this transferring process is not good enough.

With advancements of the electricity industries, generally, the configuration and quality of supplying power in the electricity system tends to intellectualized and energy conservation. These issues are considered due to the energy resources in global are limited, and carbon-dioxide (CO₂) emissions causes serious issues in every countries in global. Therefore, new alternative energy of the currently power system development tends to select renewable energy, which could be recycle without deficiency, such as solar energy, wind power, fuel cells, tidal energy, geothermal energy, wave energy, and so on. Generally, traditional renewable energy industries, including solar generating power system, fuel cell system, wind power system, would establish a storage system for applying uniform current and voltage. Establishment of the storage system may reduce the power quantity offered from the remote terminal by transmitting wires and reduce power loss for improving efficiency of supplying power.

The power quality of the renewable energy systems relates to how long the sustaining power offered by the systems is, and the efficiency of the systems, which depends on whether the storage energy in the internal parts of the renewable energy resource systems (RERS) may be controlled or operated for continuing to supply power to a load, and to store energy for achieving the goal of constantly supplying power. In general, the storage system of the RERS may involves the usage of a set of batteries, and the advantages of the batteries is that the charging or discharging of the batteries is smooth, easy to obtain, and high safety. The storage devices of the normal RERS may analysis the feedback voltage signal of the batteries, followed by charging the batteries and protecting for the batteries based on the analysis of the feedback signal for applying a constant and stable DC voltage across through a sensitive load for preventing the preciseness of the apparatus from being affected by the variation of the voltage. A high capacitance is required when the system compensates a sharp voltage variation in the system in a long duration, especially at the situation of system voltage drops, the primary considerations is the compensation time and performance of the RERS depend on whether or not the storage energy in the RERS can be controlled and operated to fulfill the total compensation and the expected results.

Furthermore, the power transferring architectures of the normal local RERS introduced a back-up power device with single direction, typically. However, this device would not involve the configuration and the advantages, such as various distributing way and mixing operating system, of the micro power grid system. In results, the local region could not receive the power from the RERS if the storage back-up power device in the local region is malfunction. The well-known architectures of the AC power transmitting system also have some problems, such as unbalancing three-phases and divergent power synchronism issues. Moreover, the transformers and the inductive loading elements will cause some unexpected surge due to the switches are switched too often.

Otherwise, even though the power generated from the RERS is DC voltage, the DC voltage still has to be converted to AC voltage through a DC-AC converter initially to match the standard of the existing power supplying system and switch boards in normal households. Subsequently, the AC voltage should be transferred to DC voltage again through an AC-DC converter to fit every application devices in the households. In results, the solar power system for environmental protection should suffer at least two times of power converting processes between the DC and the AC, and it causes the efficiency of practical electricity loss dramatically.

### SUMMARY

One object of the present invention is to solve the problems of energy loss generated by several converting processes between AC and DC voltages from the power company to for the general household.

Another object of the present invention is to provide a system, which may effectively control and manage power distribution between grids.

In order to reach the foregoing objects, the present invention provides a networklized DC power system, which comprises a micro DC grid and a plurality of energy routers separately connected to the micro DC grid. Each of energy routers comprises: a controlling module for controlling the energy router; a DC receiving port coupled to the controlling module for receiving DC power from at least one DC power generating system; an AC receiving port coupled to the controlling module for receiving AC power from an AC power supplying system; a battery charging/discharging port coupled to the controlling module and a battery system for charging or discharging the battery system; a DC outputting port coupled to the controlling module and a load for applying DC voltage to the load; and a network interface port coupled to the controlling module and the micro DC grid for receiving the power from the micro DC grid or for transferring power to other energy routers of the micro DC grid.

In some embodiments of the present invention, the controlling module further comprises: a processing unit, a DC-DC converter, an AC-DC converter, a battery status monitoring unit and a network power monitoring unit. The DC-DC converter is coupled to the processing unit, and the AC-DC converter is coupled to the AC receiving port, the processing unit and the DC-DC converter for receiving AC power and transferring to DC power, and outputting to the DC-DC converter depending on instructions from the processing unit. The battery status monitoring unit is coupled to the battery charging/discharging port, the processing unit and the DC-DC converter. The battery status is monitored through the battery charging/discharging port and responses to the processing unit, and the processing unit transforms charging or discharging instructions to the battery status monitoring unit and the DC-DC converter based on the monitoring results. The network power monitoring unit is coupled to the DC-DC converter and the network interface port, and coupled to the processing unit through the DC-DC converter for receiving information from the other energy routers of the micro DC grid and sending the information to the processing unit. The processing unit determines whether drawing power from the micro DC grid to the DC-DC converter or outputting power from the DC-DC converter to the micro DC grid depending the information.

Moreover, the present invention also provides a networklized DC power system, which comprises: a micro DC grid and a plurality of energy routers separately connected to the micro DC grid. Each of said energy routers comprises: a first sub-energy router, a second sub-energy router and a network interface port, wherein the first sub-energy router connected with the second sub-energy router in series. The first sub-energy router further comprises: a first controlling module, for controlling the first sub-energy router; an AC receiving port, coupled to the first controlling module for receiving AC power from an AC power supplying system; a battery charging/discharging port, coupled to the first controlling module and a battery system for charging or discharging the battery system. The second sub-energy route further comprises: a second controlling module, for controlling the second sub-energy router; a DC receiving port, coupled to the second controlling module for receiving DC power from at least one DC power generating system; and a DC outputting port, coupled to the second controlling module and a load for applying DC power to the load. Furthermore, the network interface port is electronically coupled to the first sub-energy router, the second sub-energy router, and the micro DC grid for receiving power from the micro DC grid or for outputting power to the other energy routers of the micro DC grid.

In certain embodiments of the present invention, the first controlling module further comprises: a first processing unit, a first DC-DC converter, an AC-DC converter and a battery status monitoring unit. The first DC-DC converter is coupled to the first processing unit, and the AC-DC converter is coupled to the AC receiving port, the first processing unit and the first DC-DC converter for receiving instructions from the first processing unit and transferring the AC power from the AC receiving port to DC power. Finally, outputting the DC power to the first DC-DC converter. Further, the battery status monitoring unit is coupled to the battery charging/discharging port. The first processing unit and the first DC-DC converter. The battery status is monitored through the battery charging/discharging port and responses to the first processing unit. The first processing unit transforms charging or discharging instructions to the battery status monitoring unit and the first DC-DC converter depending on the monitoring results.

In another certain embodiments of the present invention, the second controlling module further comprises: a second processing unit, a second DC-DC converter and a network power monitoring unit. The second DC-DC converter is coupled to the second processing unit, and the network power monitoring unit is coupled to the second DC-DC converter and the network interface port. Moreover, the network power monitoring unit is electronically coupled to the second processing unit through the second DC-DC converter for receiving information from the other energy routers of the micro DC grid and sending the information to the second processing unit. The second processing unit determines whether drawing power from the micro DC grid to the second DC-DC converter or outputting power from the second DC-DC converter to the micro DC grid depending on the received information.

Furthermore, the present invention provides still another networklized DC power system, which comprises: a grid-tie energy router and a plurality of DC power systems. The grid-tie energy router comprises: a processing module for controlling said grid-tie energy router; a DC-DC converter module coupled to the processing module; and a plurality of connecting ports separately coupled to the DC-DC converter module, and electronically connected to the processing module through the DC-DC converter module. Moreover, the plurality of DC power systems are electronically connected to the plurality of connecting ports separately. Each of the DC power systems includes a micro DC grid and a plurality of energy routers for distributing and assigning power to the plurality of DC power systems by the grid-tie energy router for extending the regions of supplying power.

In certain embodiments of the present invention, the managing protocols of the foregoing network interface port comprises: RS232, RS485 or local area network (LAN). In additional, in another certain embodiments of the present invention, the DC voltages supplied from the DC power systems comprise: 120V, 240V, 360V or 400V (the maximum value of the DC voltage).

As mentioned-above, the foregoing networklized DC power system may eliminate the complicated converting process between AC voltage and DC voltage. Moreover, because the renewable energy, such as solar generating power and wind power, generates DC voltage, the networklized DC power system of the present invention may effectively reduce the loss causing from the transferring process between the AC voltage and the DC voltage.

Furthermore, the present invention may store redundant power into the battery system, and followed by, delivering the power into the micro DC grid based on the status of the energy routers and the gird-tie energy router monitoring and distributing power. Moreover, the energy routers which have insufficient power may draw power from the micro DC grid to their loads. The benefit is that some power requirements from the important loads, such as hospitals, may be offered and distributed with first priority for preventing the important load being cut off the power.

In additional, the utilization of the renewable energy, such as solar generating power system and wind power system, to generate power matches with the concept of ECO nowadays. Moreover, the system of the present invention may only modify the existing network frameworks and switchboard equipments to achieve the purpose of reducing the cost of supplying power effectively.

### BRIEF DESCRIPTION OF THE DRAWINGS

The present description will be better understood from the following detailed description read in light of the accompanying drawings, wherein:

FIG. 1 illustrates a schematic diagram illustrating an embodiment of a networked DC power system according to the present invention;

FIGS. 2A-2B illustrate circuit block diagrams illustrating the mentioned-above embodiment of an energy router according to the present invention;

FIG. 3 illustrates a schematic diagram illustrating another embodiment of a networked DC power system according to the present invention;

FIGS. 4A-4C illustrate circuit block diagrams illustrating the mentioned-above embodiment of an energy router according to the present invention;

FIG. 5 illustrates a schematic diagram illustrating still another embodiment of a networked DC power system according to the present invention; and

FIG. 6 illustrates a function diagram illustrating the mentioned-above embodiment of a grid-tie energy router according to the present invention.

### DETAILED DESCRIPTION

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

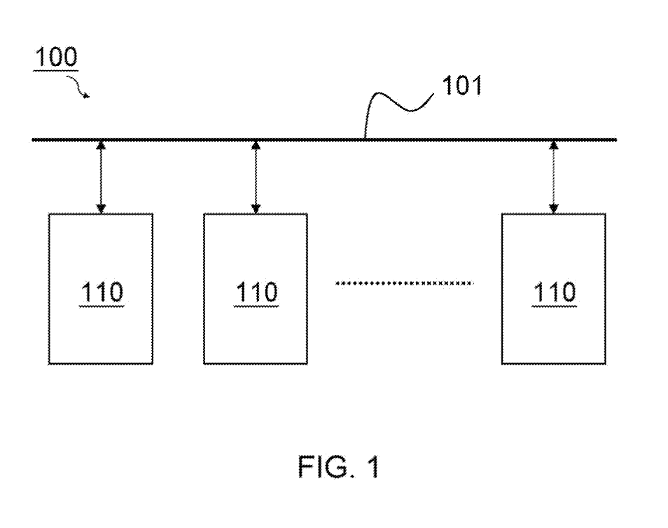

Regarding to FIG. 1, it illustrates a schematic diagram according to an embodiment of a networklized DC power system of the present invention. A networklized DC power system 100 comprises a micro DC grid 101 and a plurality of energy routers 110. The plurality of energy routers 110 are electrically connected to the micro DC grid 101, separately.

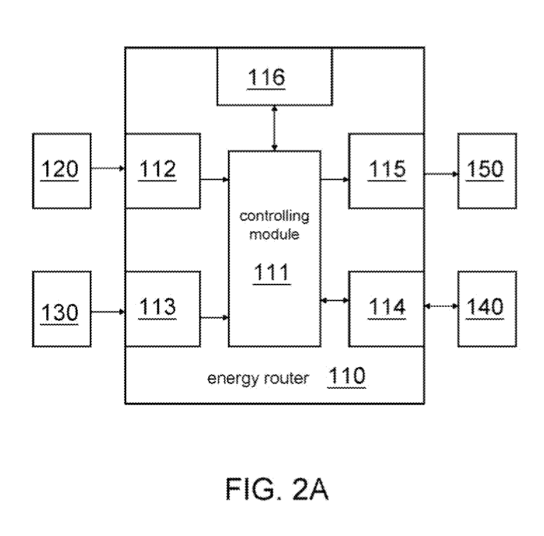

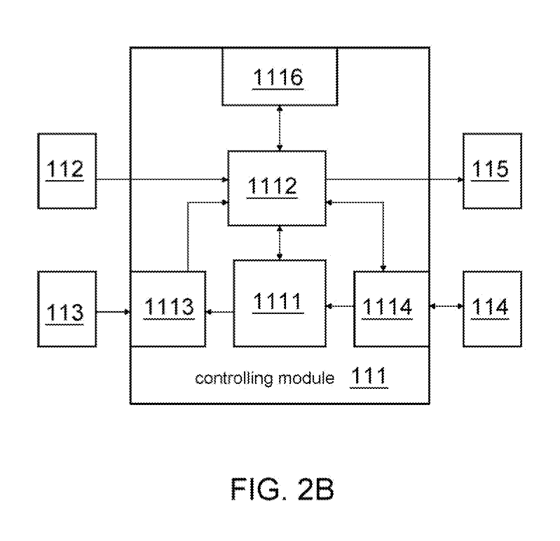

Subsequently, regarding to FIGS. 2A and 2B, they illustrate circuit block diagrams of the energy routers, and following description will accompany with references to the networklized DC power system shown in FIG. 1. Each energy router 110 comprises a controlling module 111, a DC receiving port 112, an AC receiving port 113, a battery charging/discharging port 114, a DC outputting port 115 and a network interface port 116. The DC receiving port 112, the AC receiving port 113, the battery charging/discharging port 114, the DC outputting port 115 and the network interface port 116 are electrically coupled to the controlling module 111, respectively.

Furthermore, the DC receiving port 112 is coupled to at least one DC power generating system 120 for receiving power from the DC power generating system 120. The DC power generating system 120 may comprise a renewable energy which includes, but not limited to, solar generating power system and wind power system. It is appreciated to note, although only a port illustrates in FIG. 2A, for person skilled in the art should be understood that numbers of port in the energy router 110 may be more for accompanying with the corresponding numbers of the DC power generating systems 120 for obtaining more electrical energy. It should not be limited in here.

The AC receiving port 113 is coupled to an AC power supplying system 130 for receiving power from the AC power supplying system 130. In one embodiment, the AC power supplying system 130 is an AC grid-tie from an electricity power company, but doesn't limit in this. Any unit which provides AC power should be involved in here, and should not be limited in the embodiments described in the present invention.

The battery charging/discharging port 114 is coupled to a battery system 140, and the DC outputting port 115 is coupled to at least one load 150. In some embodiments of the present invention, the battery system 140 is utilized to store energy and supply power with 120V (Volt). The total capacity of the load 150 may be 3 kW (kilowatt). These should not be limited in here.

In certain embodiments of the present invention, the battery system 140 may comprise lead acid battery, AGM battery, Gel battery or Li-Iron battery, but should not be limited in these.

Furthermore, the load 150 may provide power to multiple loading devices, and should not be limited only for powering to one loading device. For a given example to illustrate, the sum capacity of all loading devices may be equal to or lower than 3 kW while the total capacity of the load 150 is 3 kW. Therefore, in FIG. 2A, only one load 150 is illustrated for describing and not for limiting. For person skilled in the art should be understood the numbers of the loading devices connected to the system depending on the total capacity in practice.

The controlling module 111 is utilized to control the operation of the energy router 110, and the circuit construction of the controlling module 111 illustrates in FIG. 2B. The controlling module 111 may comprise a processing unit 1111, a DC-DC converter 1112, an AC-DC converter 1113, a battery status monitoring unit 1114, and a network power monitoring unit 1116.

The processing unit 1111 is electrically connected to the DC-DC converter 1112, the AC-DC converter 1113 and the battery status monitoring unit 1114. The DC-DC converter 1112 may also be electrically coupled to the AC-DC converter 1113, the battery status monitoring unit 1114 and the network power monitoring unit 1116, and the network power monitoring unit 1116 further is electrically coupled to the processing unit 1111 through the DC-DC converter 1112. Furthermore, the DC-DC converter 1112 is electrically connected to the DC receiving port 112 and DC outputting port 115 for receiving power from the DC power generating system 120 and transferring power to the load 115.

In some embodiments of the present invention, the foregoing DC-DC converter 1113 may be a bidirectional DC-DC converter, but should be not limited in this.

Moreover, the AC-DC converter 1113 is coupled to the AC receiving port 113. The AC-DC converter 1113 received instructions from the processing unit 1111 to convert AC power received from the AC receiving port 113 to DC power, and output the DC power to the DC-DC converter 1112. Then, the DC-DC converter 1112 will integrate all of receiving DC power depending on instructions of the processing unit 1111. In certain embodiments of the present invention, the AC-DC converter 1113 may further comprise a switching device (not shown) for determining whether or not receiving power from the AC power supplying system based on the on or off status of the switching device. Thus, the connection between the AC receiving port 113 and the AC power supplying system 130 may be cut-off by the switching device during the price of power from the AC power supplying system is high for not using the gird-tie provided from the electricity power company.

The battery status monitoring unit 1114 is coupled to the battery charging/discharging port 114 for monitoring the status of the battery system 140 through the battery charging/discharging port 114. Subsequently, the battery status monitoring unit 1114 will transfer the monitoring results to the processing unit 1111. The status of the battery system 140 described in here may comprise various status of the battery system 140, such as fully charging status or low battery status. Thus, the processing unit 1111 will base on the received status information of the battery system 140 to determine whether instructing the DC-DC converter 1112 to supply power to charge the battery system 140 through the battery status monitoring unit 1114 and the battery charging/discharging port 114, or instructing the battery status monitoring unit 1114 to draw power from the battery system 140 through the battery charging/discharging port 114 and transfer the power back to DC-DC converter 1112 for discharging.

The network power monitoring unit 1116 is coupled to the network interface port 116 for receiving information and power from the micro DC grid 101 through the network interface port 116. The information may comprise the status of other energy routers. Subsequently, the power and information of the energy router 110 may also be transferred to the micro DC grid 101 through the network interface port 116. In some embodiments, the processing unit 1111 determines the power distribution depends on the parameters determined from the power status received from the DC-DC converter 1112, and the power requirement status provided to the load 150 and the status of the battery system 140. If the required power is insufficient, the processing unit 1111 will instruct the DC-DC converter 1112 and the network power monitoring unit 1116 to extract power from the micro DC grid 101. On the contrary, if there is redundant power, this power may deliver to the micro DC grid 101 through the network interface port 116. In this embodiment, mechanisms of power distribution may construct from the difference of voltages, for example, the power from a port with high voltage to a port with low voltage. However, this should not be limited in here.

In another certain embodiments, the processing unit 1111 also may communicate with other energy routers 110 of the micro DC grid 101 via the network power monitoring unit 1116 and the network interface port 116. If some important loads 150 connect to the other energy routers 110, this system may provide power to the important loads 150 with priority for maintaining the operating of the important loads 150.

It is noted that the energy router 110 described here may further comprise some features as memory units for storing related operating data, such as operating software of controlling interface. Furthermore, the system according to the present invention may connect to some additional devices, such as display devices, input devices for users to operate this system. However, such features will be easily added to or omitted from this system referencing the description of the present invention for practicing to any person skilled in the art, therefore, no longer details here.

Thus, the networklized DC power system disclosed in the present invention may distribute power in the micro DC gird effectively, and have capacity of designation depending on the priority levels of loads to distribute power to the priority load with priority. Moreover, the micro DC grid is operated without converting between the AC and the DC too many times for reducing power loss during the converting process effectively and matching with the requirement of ECO. Furthermore, power is managed by the network interface not only delivering the power, but also delivering information of each energy router to the micro DC grid synchronously, and making the management of power more effectively.

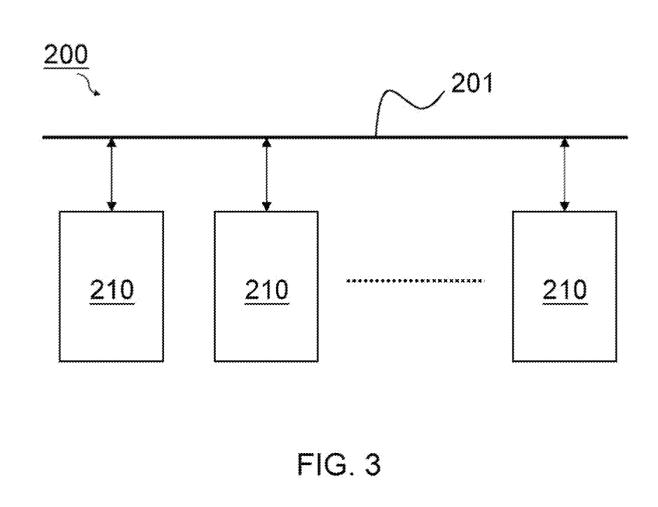

Subsequently, please referring to FIG. 3, it shows a networklized DC power system according to another embodiment of the present invention. Similar to the embodiment described in FIG. 1, a networklized DC power system 200 comprises a micro DC grid 201 and a plurality of energy routers 210. The plurality of energy routers 210 are separately connected to the micro DC grid 201.

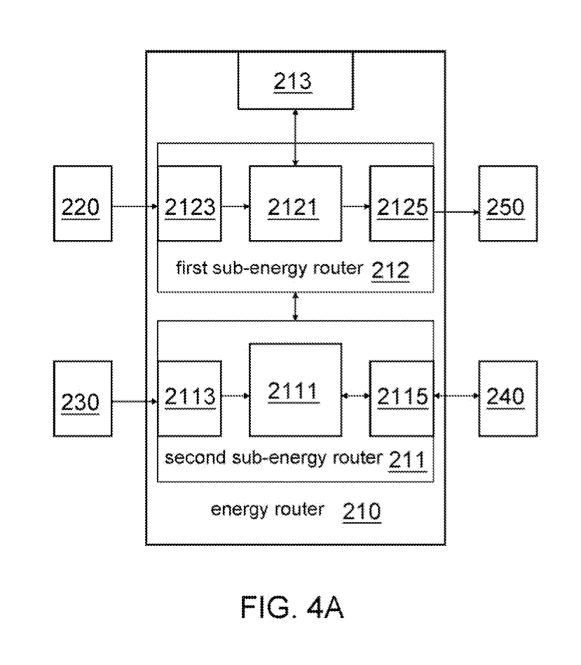

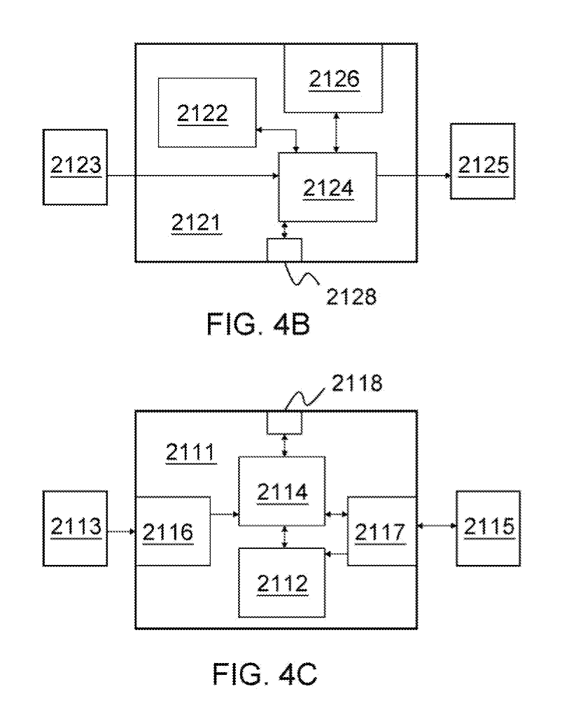

In FIGS. 4A-4C, they illustrate circuit block diagrams of the energy router then accompanying with the networklized DC power system shown in FIG. 3 for describing. Each energy router 210 comprises a first sub-energy router 211, a second sub-energy router 212 and a network interface port 213. The difference between the energy router 210 and the energy router 110 shown in FIG. 1 is that the energy router 210 is constructed from two sub-energy routers 211, 212 which are both connected in series. Moreover, the sub-energy router 211, 212 may control and process different functions, respectively. The network interface port 213 is electrically coupled to the first sub-energy router 211 and the second sub-energy router 212. Thus, the energy router 210 is coupled to transmit and receive power and information to the micro DC grid 201 via the network interface port 213.

The first sub-energy router 211 comprises a first controlling module 2111, an AC receiving port 2113 and a battery charging/discharging port 2115. The first controlling module 2111 is coupled to an AC power supplying system 230 through the AC receiving port 2113, and the first controlling module 2111 is coupled to a battery system 240 through the battery charging/discharging port 2115.

In one embodiment, the AC power supplying system 230 is an AC grid-tie from an electricity power company, but doesn't limit in this. Any unit which provides AC power should be involved in here, and should not be limited in the embodiments described in the present invention.

In some embodiments of the present invention, the battery system 240 is utilized to store energy and supply power with 240V. These should not be limited in here. In addition, in certain embodiments of the present invention, the battery system 240 may comprise lead acid battery, AGM battery, Gel battery or Li-Iron battery, but should not be limited in these.

The first controlling module 2111 comprises a first processing 2112, a first DC-DC converter 2114, an AC-DC converter 2116, a battery status monitoring unit 2117 and a first connecting port 2118. The first processing unit 2112 is coupled to the first DC-DC converter 2114 and the battery status monitoring unit 2117, and the AC-DC converter 2116 is electrically coupled to the first processing unit 2112 through the first DC-DC converter 2114. The operating acts of first processing unit 2112, the first DC-DC converter 2114, the AC-DC converter 2116 and the battery status monitoring unit 2117 are similar with the foregoing embodiments described before, therefore, no longer details here.

The second sub-energy router 212 comprises a second controlling module 2121, a DC receiving port 2123 and a DC outputting port 2125. The second controlling module 2121 is coupled to the DC power generating system 220 through the DC receiving port 2123, and the second controlling module 2121 is also coupled to a load 250 through the DC outputting port 2125.

Similarly, the DC power generating system 220 may also comprise a renewable energy, such as solar generating power system and wind power system, but do not limit in these.

In certain embodiments of the present invention, the total capacity of the load 250 may be 6 kW, but should not be limited in this figure. Furthermore, the load 250 may provide power to multiple loading devices, and should not be limited only powering to one loading device. Therefore, in FIG. 4A, only one load 250 is illustrated for describing and not for limiting. For person skilled in the art should be understood the numbers of the loading devices connected to the load 250 depending on the total capacity in practice.

The second controlling module 2121 comprises a second processing unit 2122, a second DC-DC converter 2124, a network power monitoring unit 2126 and a second connecting port 2128. The first sub-energy router 211 and the second sub-energy router 212 are coupled together in series by connecting the first connecting port 2118 and the second connecting port 2128. The second processing unit 2122 is coupled to the second DC-DC converter 2124, and the network power monitoring unit 2126 is electrically coupled to the second processing unit 2122 through the second DC-DC converter 2124. The operating acts of the second processing unit 2122, the second DC-DC converter 2114 and the network power monitoring unit 2126 are similar with the foregoing embodiments, therefore, no longer details here.

In this embodiment, utilizing the processing units 2112, 2122 and the DC-DC converters 2114, 2124 disposed in the two sub-energy routers 211, 212, respectively, to divide the work functions, and combining the two sub-energy routers 211, 212 in series to construct the networked DC power system according to the present invention. Thus, comparing with the embodiment illustrated in FIG. 1 and FIGS. 2A-2B, the processing units 2112, 2122 and the DC-DC converters 2114, 2124 may use cheaper product for reducing cost.

In addition, the energy router 210, which is constructed with the two sub-energy routers 211, 212 connected in series, may enhance the value of the available voltage effectively for making the power distribution more efficiency.

However, the networklized DC power systems 100, 200 illustrated in FIG. 1 and FIG. 3 determine the power distribution depending on the status of the other energy routers in the micro DC grids 101, 201 received by each of energy router 110, 210. Thus, the practical available regions of the networked DC power system 100, 200 will be restricted.

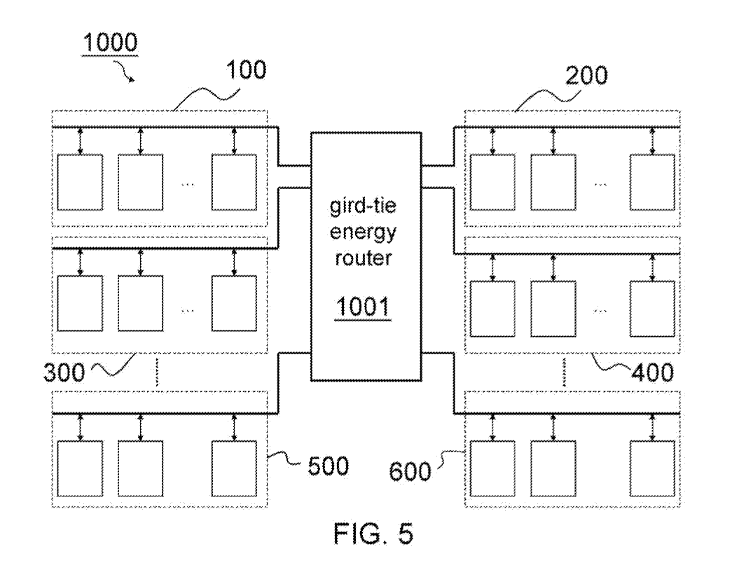

Please subsequently referring to FIG. 5, it illustrates a diagram of a networklized DC power system of still another embodiment according to the present invention. In this embodiment, the networklized DC power system 1000 includes a gird-tie energy router 1001 to act a central controlling terminal, and the gird-tie energy router 1001 is connected to a plurality of DC power systems 100, 200, 300, 400, 500, 600, which may maximize to one hundred DC power systems, for extending the range of power to distribute and manage.

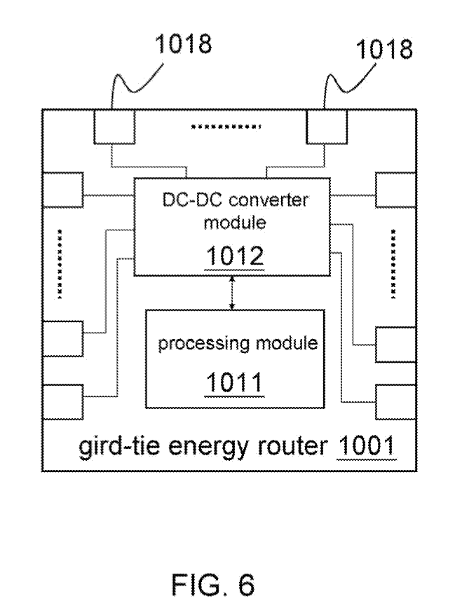

FIG. 6 illustrates a circuit block of the gird-tie energy router of still another embodiment according to the present invention. The gird-tie energy router 1001 comprises a processing module 1011, a set of DC-DC converters 1012 and a plurality of connecting ports 1018. The numbers of the connecting ports 1018 may depend on the numbers of the connected DC power system, and may maximize to one hundred connecting ports 1018.

The processing module 1011 may comprise one, two or more processors, and the combination of those, for managing and distributing the power. The set of DC-DC converters 1012 may also comprise one, two or more DC-DC converters, and the combination of those, for rectifying all DC current from all DC power systems 100, 200, 300, 400, 500, 600 into the networked DC power system 1000.

In some embodiments, the DC power systems 100, 200, 300, 400, 500, 600 all may be the DC power system illustrated in FIG. 1. In others embodiments, the DC power systems 100, 200, 300, 400, 500, 600 all may be the DC power system illustrated in FIG. 3. In still other embodiments, the DC power system 100, 200, 300, 400, 500, 600 may parts of the DC power system illustrated in FIG. 1 and parts of the DC power system illustrated in FIG. 3. These should not be limited.

In certain embodiments of the present invention, the networklized DC power system may be constructed by power over Ethernet (PoE). The PoE adopts all standards of IEEE 802.3af/802.3at, and this design may not reduce the communicating performance of the network data and the transmitting distance of the network. When the equipments are supported each other, the power will be active automatically, otherwise, the power will not be turn-on when the equipments are not supported each other. This characteristic of the present system may make users combining several transitional equipments to the equipments supported to the PoE in any time.

Furthermore, in one embodiment of the present invention, the networklized DC power system 1000 may deal with total capacity approaching to 1 MW while the operating voltage of the networklized DC power system 1000 is 240V. In another embodiment of the present invention, the networklized DC power system 1000 may deal with total capacity larger than 1 MW while the is operating voltage of each DC power system is 240V and the available operating voltage of the gird-tie energy router 1001 may be 400V.

In additional, in still another certain embodiments of the present invention, the DC voltages supplied from the DC power system may comprise 120V, 240V, 360V or 400V (the maximum value of the DC voltage), due to those addable DC voltages.

In the preferred embodiment of the present invention, the networklized DC power system 1000 may deal with the total capacity approaching to 1 MW, and ten DC power systems are connected to the gird-tie energy router 1001. Each of DC power system further comprises forty energy routers, and the total capacity of the loads of each of energy router may be 2.5 kW, wherein the loads is ten in average. Thus, in this embodiment, the system may comprise four thousands loads or hundred thousands virtual mechanisms.

As mentioned-above, the foregoing networklized DC power system may eliminate the complicated transferring process of AC voltage and DC voltage. Moreover, because the renewable energy, such as solar generating power and wind power, generates DC voltage, the networklized DC power system of the present invention may reduce the loss causing from the converting process of AC voltage and DC voltage effectively.

Furthermore, depending on the energy routers and the gird-tie energy router monitoring and distributing power, the present invention may store redundant power into the battery system, and then, delivering the power into the micro DC grid. Moreover, the energy routers which do not have sufficient power may draw power from the micro DC grid to their loads. The present supports priority assignation to assign power to the important load, such as hospitals, from the better for preventing the important load from being cut off the power.

In additional, the utilization of the renewable energy, such as solar generating power system and wind power system, to generate power matches with the concept of ECO nowadays. Moreover, the system of the present invention may only modify the existing network frameworks and switchboard equipments to achieve for reducing the cost of supplying power effectively.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

What is claimed is:

1. A networklized DC power system, comprising:
a micro DC grid; and
a plurality of energy routers, separately connected to said micro DC grid, each of said energy routers comprising:
a controlling module for controlling said energy router;
a DC receiving port, coupled to the controlling module for receiving DC power from at least one DC power generating system;
an AC receiving port, coupled to the controlling module for receiving AC power from an AC power supplying system;
a battery charging/discharging port, coupled to the controlling module and a battery system for charging or discharging the battery system;
a DC outputting port, coupled to the controlling module and a load for applying DC voltage to the load; and
is a network interface port, coupled to the controlling module and said micro DC grid for receiving the power from said micro DC grid or for transferring power to other energy routers of said micro DC grid.

2. The networklized DC power system of the claim 1, wherein the controlling module comprising:
a processing unit;
a DC-DC converter, coupled to the processing unit;
an AC-DC converter, coupled to the AC receiving port, the processing unit and the DC-DC converter for receiving AC power and converting to DC power, and outputting to the DC-DC converter;
a battery status monitoring unit, coupled to the battery charging/discharging port, the processing unit and the DC-DC converter, the battery status monitored through the battery charging/discharging port and response to the processing unit, and the processing unit transforming charging or discharging instructions to the battery status monitoring unit and the DC-DC converter; and
a network power monitoring unit, coupled to the DC-DC converter and the network interface port, coupled to processing unit through the DC-DC converter for receiving information from the other energy routers of said micro DC grid and sending the information to the processing unit, the processing unit determining whether drawing power from the micro DC grid to the DC-DC converter or outputting power from the DC-DC converter to the micro DC grid.

3. The networklized DC power system of the claim 1, wherein managing protocols of the network interface port comprising: RS232, RS485 or local area network (LAN).

4. A networklized DC power system, comprising:
a micro DC grid; and
a plurality of energy routers, separately connected to said micro DC grid, each of said energy routers comprising:
a first sub-energy router, comprising:
a first controlling module, for controlling the first sub-energy router;
an AC receiving port, coupled to the first controlling module for receiving AC power from an AC power supplying system;
a battery charging/discharging port, coupled to the first controlling module and a battery system for charging or discharging the battery system;
a second sub-energy router, connected with the first sub-energy router in series, the second sub-energy router comprising:
a second controlling module, for controlling the second sub-energy router;
a DC receiving port, coupled to the second controlling module for receiving DC power from at least one DC power generating system; and
a DC outputting port, coupled to the second controlling module and a load for applying DC power to the load; and
a network interface port, electronically coupled to the first sub-energy router, the second sub-energy router, and said micro DC grid for receiving power from said micro DC grid or for outputting power to the other energy routers of said micro DC grid.

5. The networklized DC power system of the claim 4, wherein the first controlling module comprises:
a first processing unit;
a first DC-DC converter, coupled to the first processing unit;
an AC-DC converter, coupled to the AC receiving port, the first processing unit and the first DC-DC converter for receiving instructions from the first processing unit and converting the AC power from the AC receiving port to DC power, and outputting the DC power to the first DC-DC converter; and
a battery status monitoring unit, coupled to the battery charging/discharging port, the first processing unit and the first DC-DC converter, the battery status monitored through the battery charging/discharging port and response to the first processing unit, and the first processing unit transforming charging or discharging instructions to the battery status monitoring unit and the first DC-DC converter.

6. The networklized DC power system of the claim 4, wherein the second controlling module comprises:
a second processing unit;
a second DC-DC converter, coupled to the second processing unit; and
a network power monitoring unit, coupled to the second DC-DC converter and the network interface port, electronically coupled to second processing unit through the second DC-DC converter for receiving information from the other energy routers of said micro DC grid and sending the information to the second processing unit, the second processing unit determining whether drawing power from the micro DC grid to the second DC-DC converter or outputting power from the second DC-DC converter to the micro DC grid.

7. The networklized DC power system of the claim 4, wherein managing protocols of the network interface port comprising: RS232, RS485 or local area network (LAN).

8. A networklized DC power system, comprising:
a grid-tie energy router, comprising:
a processing module, for controlling said grid-tie energy router;
a DC-DC converter module, coupled to the processing module; and
a plurality of connecting ports, separately coupled to the DC-DC converter module, and electronically connected to the processing module through the DC-DC converter module; and
a plurality of DC power systems, electronically connected to the plurality of connecting ports separately, wherein each of the DC power systems includes a micro DC grid and a plurality of energy routers for distributing and assigning power to the plurality of DC power systems by said grid-tie energy router.

9. The networklized DC power system of claim 8, wherein parts of or all the energy routers comprise:
a controlling module, for controlling the energy router;
a DC receiving port, coupled to the controlling module for receiving DC power from at least one DC power generating system;
an AC receiving port, coupled to the controlling module for receiving AC power from an AC power supplying system;
a battery charging/discharging port, coupled to the processing module and a battery system for charging or discharging the battery system;
a DC outputting port, coupled to the processing module and at least one load for applying DC power to the load; and
a network interface port, coupled to the controlling module and the micro DC grid for receiving power from the micro DC grid or outputting power to the micro DC grid.

10. The networklized DC power system of claim 8, wherein parts of or all the energy routers comprise:
a first sub-energy router, comprising:
a first controlling module, for controlling the first sub-energy router;
an AC receiving port, coupled to the first controlling module for receiving AC power from an AC power supplying system; and
a battery charging/discharging port, coupled to the first controlling module and a battery system for charging or discharging the battery system;
a second sub-energy router, connected with the first sub-energy router in series, the second sub-energy router comprising:
a second controlling module, for controlling the second sub-energy router;
a DC receiving port, coupled to the second controlling module for receiving DC power from at least one DC power generating system; and
a DC outputting port, coupled to the second controlling module and a load for applying DC power to the load; and
a network interface port, electronically coupled to the first sub-energy router, the second sub-energy router, and said micro DC grid for receiving power from said micro DC grid or for outputting power to the other energy routers of said micro DC grid.

11. The networklized DC power system of claim 8, wherein DC voltages supplied from the DC power systems comprise: 120V, 240V, 360V or 400V.
